(19) United States
(12) Patent Application Publication
(10) Pub. No.: US 2008/0215617 A1
(43) Pub. Date: Sep. 4, 2008

(54) METHOD FOR USING PSYCHOLOGICAL STATES TO INDEX DATABASES

(76) Inventors: Guillermo Alberto CECCHI, New York, NY (US); Ravishankar Rao, Elmsford, NY (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 12/049,530

(22) Filed: Mar. 17, 2008

Related U.S. Application Data
(63) Continuation of application No. 11/330,415, filed on Jan. 10, 2006.

(51) Int. Cl. G06F 17/00

(52) U.S. Cl. 707/103 R; 707/E17.055

(57) ABSTRACT

The present invention provides a method for capturing and storing physiological response attributes measured from a user while different stimuli are presented. Each stimulus may be any multimedia object, for example text, picture, or audio/video. The measured physiological response attributes are paired with the input stimulus, and stored conjointly in one or more databases. The physiological response attributes measure an aspect of the user known as emotional valence, and relate to the emotional state of the user, such as angry or sad. The database of physiological responses attributes of multiple users is first established. Then, when the physiological response attributes of a specific user in the future is examined, the system can suggest which objects in the database best correspond. Moreover, the database can be constructed based on the responses of the individual user for their own utilization, and be updated over the course of its continued use.

### BACKGROUND OF THE INVENTION

1. Field of the Invention

The present invention relates to the field of measuring emotional and physiological responses in human subjects, and more particularly to the fields of storing and using semantic networks and databases to correlate emotional responses of users and/or groups of users with stimuli in the form of media objects.

2. Background Description

As computers become more interactive and user-centric, the response of a computer system can be tailored to the specific user who is using the system. This can be done in a multitude of ways, including explicit identification of the user and understanding the preferences of the user based on past histories of interaction. Another method is to determine the emotional state of the user in order to steer the interaction between the computer and the user.

At the same time, collections of objects, such as words and media objects are getting more sophisticated. One method of organizing words is to create a semantic network where different types of relationships between words are captured in a network. Media objects such as pictures, music and video are being organized in relational databases where they can be efficiently stored, retrieved and searched. However, the existing mechanisms that can be deployed for search are quite limited, and are restricted to keywords or specific examples specified by the user.

A need therefore exists for combining the measurement of human emotion with collections of objects such as words or media objects, in such a way that the entire experience of a user with a computer becomes more interactive.

### RELATED ART

U.S. Pat. No. 6,190,314 covers a method of measuring physiological attributes of a user and determining the degree of correlation to a pre-defined set of six emotions (anger, disgust, fear, joy, surprise and sadness). This patent is very different from what we are proposing in two ways. Firstly, we do not create a set of pre-defined emotional states. Secondly, the aspect of creating an interlinked database of physiological attributes and media objects does not exist in U.S. Pat. No. 6,190,314.

U.S. Pat. No. 6,697,457 is not measuring physiological attributes of a user directly, but rather inferring the emotional state of the user based on a stored voice message. Again, the aspect of using a conjoint database of physiological attributes and media objects such that the physiological attributes provide an index into the database does not exist.

Though U.S. Pat. No. 6,871,199 deals with semantic nets, there is no aspect of this reference that addresses the measurement and use of the physiological state of the user.

Similarly, U.S. Pat. No. 6,556,964 B2 provides a method to infer meaning in a natural language sentence, but does not address physiological attributes.

Patent JP 2003-157253A deals solely with extracting implied emotion in a written sentence. No physiological attributes are measured.

U.S. Pat. Nos. 6,480,826, 6,757,362 and 6,721,704 B1 cover methods for detecting emotional state in a user's voice and adjusting the response of a computer system based on the perceived emotional state. U.S. Pat. No. 6,385,581 B1 is similar to these references in that emotional state in a textual stream of words is detected, and this inferred emotional state is used to produce appropriate background sounds. There is no aspect in these four references that addresses the issue of creating a conjoint database of physiological attributes and media objects such that the physiological attributes provide an index into the database.

U.S. Pat. No. 6,782,341 B2 specifically deals with the determination of emotional states of an artificial creature. There are no physiological measurements made on a human subject. Furthermore the issue of creating a database of media objects with the physiological attributes as an index is not addressed.

U.S. Pat. No. 6,332,143 addresses the problem of detecting emotion in written text. No direct physiological attributes are measured from a user.

### SUMMARY OF THE INVENTION

The invention consists of creating a database of physiological attributes evoked by multi-media objects (i.e., stimuli), which serves as an index to look up those objects, and vice versa.

It is therefore an exemplary embodiment of the present invention to provide a method for capturing and storing physiological signals measured from a user while different stimuli are presented.

Another exemplary embodiment of the invention deals with using the relationship between a media object and the physiological response it evokes to predict media objects that are most highly associated with this state.

A further exemplary embodiment of the invention deals with the combination of the physiological responses of several users to create a single expected response profile According to the invention, there is provided a database and a method of using the database of physiological responses of multiple users so that when the physiological response of a specific user in the future is examined, the system can suggest which media objects in the database best correspond to this physiological response. Moreover, the database can be constructed based solely on the responses of the individual user for his/her own utilization, and be updated and refined over the course of its continued use. The stimulus used to elicit the physiological responses may be any multimedia object, for example a written word, or a picture, or audio/video. The measured physiological signals are paired with the input stimulus, and stored conjointly in a database.

This could be done by providing additional indexing fields in the database that represent the emotional state of the user. As an example, this would enable the computer system to automatically suggest appropriate options or actions for the user based on comparing the measured emotional state with those that exist in the database, and retrieving those media objects that have a similar associated emotional state. This can also facilitate searches by reducing the need to provide several search terms by extracting implicit search terms based on the emotional state of the user. This aspect of creating a database of measurements of physiological attributes that are associated with multimedia objects is novel, both in terms of issued patents and of current computer science and neurophysiological research.

The physiological signals measure an aspect of the user known as emotional valence, and relate to the emotional state of the user, such as angry or sad. For the purposes of this invention, the term “emotional valence” may be used interchangeably with the term “emotional labels,” or just “labels”. Eventually, the physiological measurements can be more general and include aspects of the user's state other than just the emotional valence, in particular those aspects that are not directly accessible to language or consciousness, but are known to influence behavior. Used in this manner, the physiological state becomes an implicit keyword in a database search. The term ‘implicit’ for the purposes of this invention is defined as the physiological state of the user that does not need to be explicitly stated as a specific keyword.

In addition, the combination of physiological responses of several users provides for an effective compression of the response signals. This expected response profile can be further compressed by extracting relevant statistics using techniques such as principal component analysis.

These and other objects, features and advantages of the present invention will become apparent from the following detailed description of illustrative embodiments thereof, which is to be read in connection with the accompanying drawings.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 illustrates a preferred embodiment of the computer resources utilized for the invention.

FIG. 2 shows a flow chart depicting the method for database construction.

FIG. 3 provides a flowchart depicting the method for the retrieval of multimedia objects that correspond to emotional states.

FIG. 4 illustrates the use of a meta-thesaurus where the links are built by measuring physiologically similar responses caused by the objects.

### DETAILED DESCRIPTION OF A PREFERRED EMBODIMENT OF THE INVENTION

Human emotions play an important role in decision making and behavior generation. For instance, a user's underlying mood or emotion may influence their decision to choose one object over another, as in choosing a fast paced piece of music when the user is in a happy mood, as opposed to a slow, funeral dirge. Similarly, if the user is in an angry mood, and writing a letter of complaint, they would have a tendency to pick words with an aggressive connotation. Thus the emotional state of a person is a good predictor of the future actions the person may undertake.

However, human subjects are not very good at describing their own emotional state. Thus, asking a human to describe his or her state and use it as a way to gauge future actions is a difficult task. The way out of this dilemma is to realize that the physiological state of a person is a reasonably good indicator of the underlying emotional state. So, measurements of physiological attributes such as skin conductance, heart rate, ventilation and gaze all tell us something about the emotional state of a person. These measures have been implemented in medical equipment cheaply and with low complexity. Some of this equipment includes Electrocardiogram (EKG) and electroencephalogram EEG. The EKG equipment can quantify heart rate and other heart beat characteristics while the EEG can measure brain wave activity. These measurements have been shown to correlate with different emotional responses.

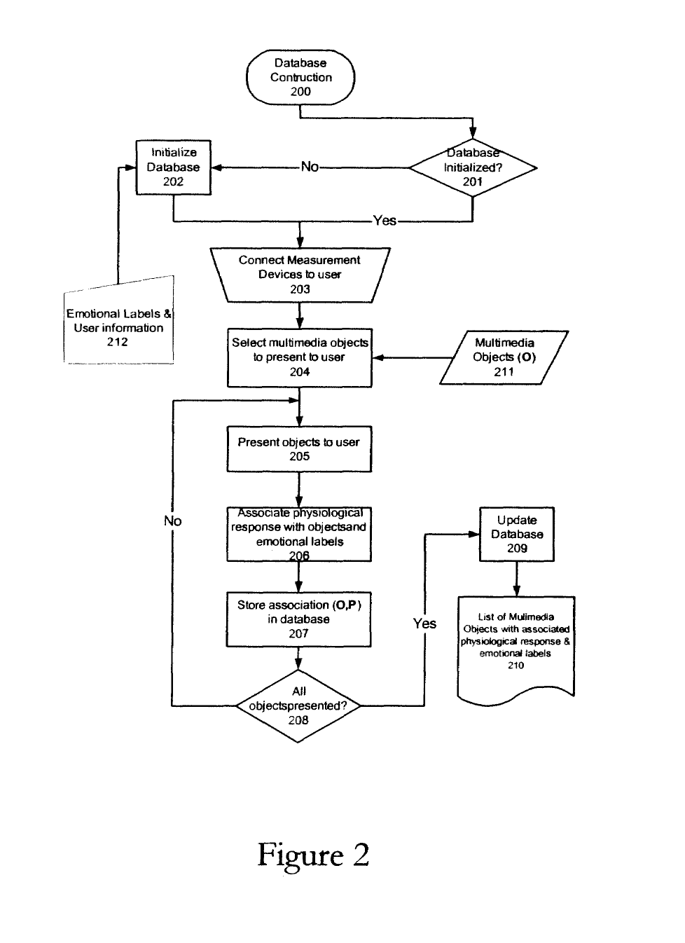

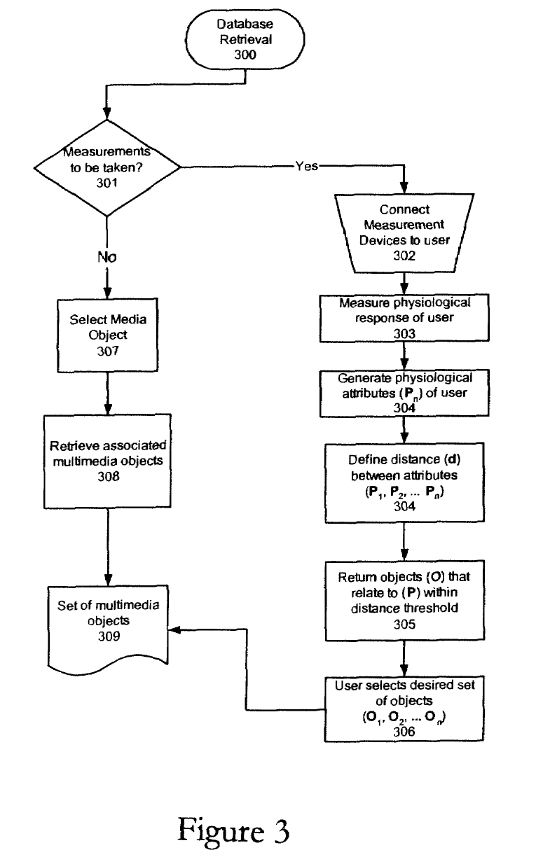

The preferred embodiment of the invention requires two modes of operation. The first phase, described in the flow chart of FIG. 2 is the database construction 200, where paired recordings of a multimedia stimulus and its response are stored in a database. The second phase, described in the flow chart of FIG. 3, is the database retrieval 300 where measurements of the physiological state of the user are continuously used to retrieve associated multimedia objects.

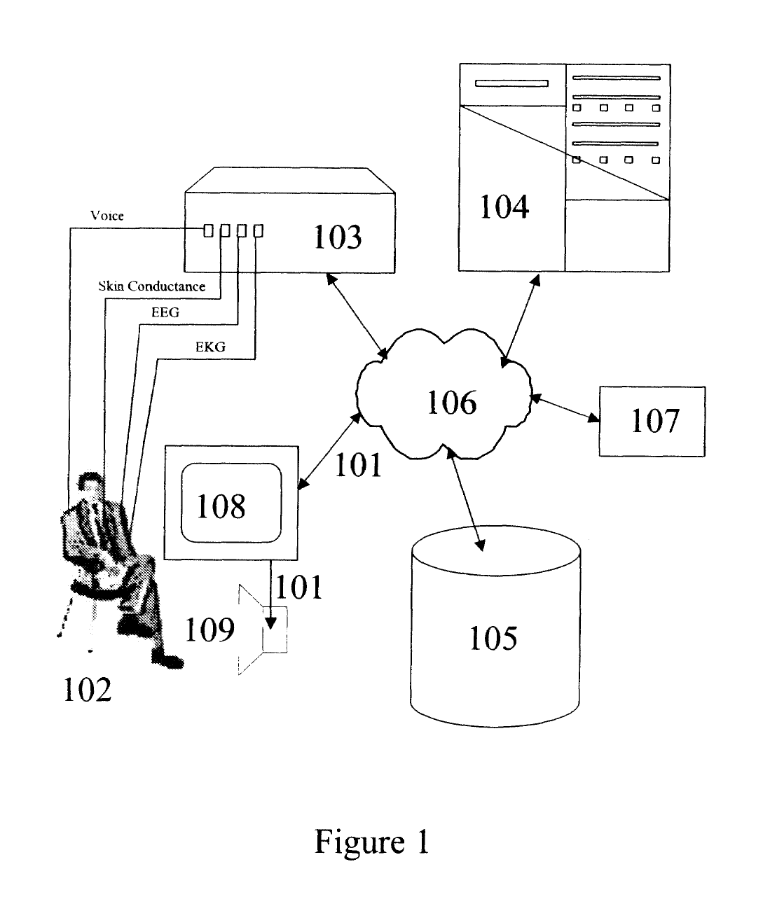

FIG. 1 describes the overall architecture used during the database construction phase. The database initially contains a collection of multimedia objects. First, an appropriate stimulus 101 is presented to the user 102. The stimulus can be derived from any multimedia object such as a word, picture, audio clip or video clip. For instance, the preferred way to create a physical stimulus from a word in a database is to display it by rendering it on a computer screen. Similarly, the preferred way to create a stimulus from an audio file in a database is to convert it to sound waves through a loudspeaker 109. The multimedia object is retrieved from the database 105 to be displayed through the preferred medium of a computer display screen 108 as a computer offers an easy way for the user to manipulate the displayed content, such as selecting an object, scrolling through selections, and deleting objects. Audio stimuli can be represented as an icon or other visual representation displayed on the computer display screen 108. When the audio file stimuli is selected, for example, by clicking a mouse on the appropriate icon or other methods of selection, the actual sound waves of the selected audio file stimuli would be presented to the user through loudspeaker 109. Other such interfaces for interaction with the multimedia objects can be used as well, such as a TV screen or physical hard copy. Hard copy (also known as paper copy) can be used so long as the description of each stimulus was known and verifiable by the database. Thus, FIG. 1 shows the presentation as a display screen but those knowledgeable in the art would understand that any form of display is possible so long as the stimulus presented is coordinated appropriately with the database.

The evoked emotions in the user 102 are measured through an interface 103 that responds to physiological attributes of the user, such as, but not limited to skin conductance, EEG, blood pressure, heart rate and voice. Some of these measurements such as skin conductance can be easily measured by placing a sensor on the keyboard of the input device, or on a computer mouse. The interface 103 consists of the actual devices used to collect the physiological attributes. The resulting measurements are collected by interface 103 and forwarded to the computer processing unit 104 as time varying signals that correspond to emotional valences, or emotional state of the user. In the case of skin conductance, the signal is a one dimensional function of time. In the case of EEG, the signal is a multi-dimensional function of time, where each electrode contributes to a dimension of the signal. The time-varying signals that represent physiological attributes are captured in a discrete, sampled form at the appropriate sampling frequency. For instance, voice can be sampled at 22 kHz, whereas skin conductance at 100 Hz, as the voice signal changes much faster than skin conductance does. As for EEG, most applications require a sampling rate of less than 1 kHz.

Once the time-varying signals are captured, the computer processing unit 104 joins the measured physiological response with the multimedia object that was used as a stimulus. The matched pairs of physiological response and associated stimuli (multimedia objects) are then stored in a database 105. Database 105 is shown as a single database, however, storage of the multimedia objects and related physiological responses may be stored in one or more databases. This database or databases may be part of the computer resources used to display the multimedia stimuli or can be connected through a network as part of other computing resources available to the system user. The capacity of the database server is sufficiently large to allow storage of the raw captured signals that represent emotional valence. Such a database can be created either for a single user, or for multiple users.

User information as well as administrative and control entries can be made through the operator interface 107. In addition, this operator interface 107 could be used to verify the association of hard copy stimuli with the appropriate physiological response stored in the one or more databases.

The elements shown in FIG. 1 are connected through network 106. The network 106 is an example of connectivity for the preferred embodiment and would allow the various elements of the system to be distributed across various computing resources in an organization. The elements could also be connected directly together and/or the elements could be part of the computer processing unit 104.

Upon completion of the database construction, the database 105 will contain the measured and collected physiological responses as attributes (P), the corresponding stimuli as multimedia objects (O), and optionally a label describing the emotion symbolically. The operator of the system may provide a ‘name’ for a set of physiological responses (or attributes) that can be used to retrieve data from the database 105. These names symbolically represent the emotions (e.g., anger, sadness, fear, etc.) that are experienced by the viewer (user) when being subjected to the stimuli (multimedia objects). For example, when a viewer is presented with an image of orphans from the 2004 Indonesian tsunami disaster, the viewer may experience difficulty breathing, and muscles may tense. The operator may label these responses as sadness either with or without querying the viewer. Although the viewer and operator are discussed as separate functions, these functions maybe performed by one individual or multiple individuals.

In addition to the emotional labels, the operator may enter, through the operator interface 107, user (or viewer) specific information. For example, an adolescent male may experience a different emotion (e.g., excitement) when presented with images of roller coaster rides while an elderly female may experience fear when presented with the same image. Therefore, it may be important to relate the stimuli, physiological responses, and emotional labels with some user information.

Referring now to FIG. 2, the flow chart depicts the steps required to perform Database Construction 200. Database construction can be performed as an initial process or can be performed periodically during the operation of the invention. That is, step 201 queries that the database has initialization data. If not, step 202 performs the initialization. Database initialization (step 202) would include loading of a set of emotional valences as a list of names that could be selected by a user and/or operator. Categories of user types could also be entered. This data is shown as input data 212 but is not meant to limit the type of data that could be used to establish the search and retrieval relations of the database. Other administrative details as appropriate could be also loaded in the database.

Once this initialization is complete, the user is connected to the various measurement devices at step 203. This connection would typically require manual tasks to be performed by the user and/or operator. However, this does not preclude the use of automated measurement devices such as infrared sensors, pressure switches in the accompanying furniture, and any number of other apparatus that does not require the subject to be actively connected by manual operation.

When the devices are connected, the stimuli are selected to be presented to the user (step 204). These stimuli are in the form of multimedia objects 211 (e.g., video images, photo images, audio, etc.) and can be stored electronically in one or more databases. These data could be loaded into the one or more databases at the initialization step 202. The selection of the stimuli can be made by the user and/or operator through the operator interface (107 of FIG. 1). These objects can also be selected automatically by a scheduling program that runs on the computer processing unit 104. This scheduling program would present a set of stimuli that have been designed to appear in a specific order and for specific durations. These stimuli may relate only to a specific target emotion, a specific target user category, or any and all of the above as well as other goals for how the sequence was designed.

Once the multimedia objects have been selected for presentation, they are presented to the user at step 205. The response of the user is measured through the measurement devices as discussed above for FIG. 1. That is, the signals from the various measurement devices are received by the device interface 103 as time varying signals. These signals are then associated (step 206) with the multimedia objects (O) presented at the time the signals were measured. The emotional response attributes (P) may also be associated with one or more symbolic emotional labels at this step. These associations may also be related to a specific category of user. Once all the associations of the presented stimuli are completed, these are stored electronically in the one or more databases at step 207. The invention then tests at step 208 to determine if all stimuli selected at step 204 have been presented. If all the selected stimuli have not been presented, the invention loops back to step 205 and presents the next stimuli to the user. After completing presentation of all selected stimuli, the invention will update the one or more databases at step 209 and generate a list of the associations recorded. This list can be printed in a hardcopy format or maybe the data contained within the one or more databases that are accessible upon query.

The database retrieval 300 operates as shown in FIG. 3. The retrieval process can be used to retrieve objects based on a measured set of physiological attributes or based on an association of objects with a specific object selected by the user. Step 301 determines if measurements are to be taken to retrieve the objects. Similar to the database construction 200 of FIG. 2, if measurements are to be taken, the user is connected to the measurement devices at step 302. Again, this connection can be performed manually or automatically as discussed above for the database construction 200. Note however, that the user in database retrieval 300 need not be the same as the user in database construction 200. Different users can be present during these two phases. In fact, it is expected that a smaller set of users is used for constructing the database 200. During the retrieval phase, the number of potential users can be arbitrarily large.

The preferred embodiment of the invention enables the physiological attributes of a user to be measured at step 302 using the appropriate apparatus, which measures attributes such as but not limited to skin conductance, EEG, heart rate, and blood pressure. This measurement apparatus could be the same as that used during database construction 200.

The physiological attributes of the user are measured at step 303 in time-sampled form as described earlier. These measurements are then translated as physiological attributes (Pₙ) at Step 304. The physiological attributes can be used as an index to retrieve associated objects in the database. This query can be stated as: “find the best matching object(s) O in the one or more databases that are associated with a measured physiological attribute P”.

Suppose the one or more databases consist of paired entries (O, P), such as (O₁, P₁), (O₂, P₂), . . . (Oₙ, Pₙ). Step 305 defines a measure of similarity d between two physiological attributes P₁ and P₂. For instance d could be related to the correlation between P₁ and P₂. This measure is formally defined as follows. Let P1(t) and P2(t) be the time-varying signals associated with the physiological responses. For the sake of simplicity, these are assumed to be 1 dimensional signals of time. Furthermore, let m1 and m2 be the mean values of the signals P1 and P2. The formula for computing the normalized cross-correlation is well known in the literature, and is defined as C=Σ((P1−m1)(P2−m2))/√(P1−m1)(P1−m1)+(P2−m2)(P2−m2)).

The value of C varies between 1 for perfectly correlated signals and 0 for uncorrelated signals. The distance measure d can be defined to be d=1−C, so that d is 0 when the signals are perfectly correlated.

Other measures of similarity can be used such as those based on comparing moments of the distributions P₁ and P₂, using for instance mutual information or Fisher information approaches.

Given a generated physiological response attribute P₁, in Step 306 the system performs the distance computation presented above, and returns all those objects O₂ (with associated physiological attributes P₂) such that d(P₁, P₂)<T where T is a threshold that signifies the degree of closeness. These objects O₂ can be ordered with respect to the measure d, such that the best matches are returned first. The returned objects are organized in the form of choices to the user. These objects have been chosen based on the current emotional state of the user, as measured by the physiological attributes, and represent those objects that are most likely to appeal to the user based on either his or her past history or the responses of a population of users. The user than selects a specific multimedia object from the set of stimuli presented to the user at step 305.

Thus for instance, if a user is writing a letter to voice a complaint, the physiological attributes measured will likely correspond to an emotional state identifiable with anger. In this case, the system can suggest appropriate words for the user to insert into his or her letter such that they correspond with the emotional state of anger or aggression. Note that this is done automatically by the system, and the user does not need to explicitly identify his emotional state to the system as one of anger. The user can then choose which word or words best suit the intended language of the letter.

In another scenario, consider a music composer, who needs to match the narrative of a drama script with the appropriate background music. While reading the script, appropriate physiological measurements could be made, and suggested music clips that match the underlying emotional state of the composer could be presented by the system.

In order to speed up processing, the different response attributes, say P₁, P₂, . . . Pₙ that n users have for a given object O can be combined in several ways. One way is to align the response attributes Pᵢ (where i ranges from 1 to n) with respect to the onset of the stimulus, and take the average of all the responses. This will generate a single response attribute, P. The database retrieval 300 outputs (309) a set of multimedia objects that are associated with physiological response attributes of a user.

Another method is to use principal component analysis to represent the set of measurements as physiological response attributes P₁, P2, . . . Pₙ, which are the responses for a single object O. Principal component analysis converts the original set of measurements to a transformed set of uncorrelated measurements. This is a well known technique in signal processing and is employed for dimensionality reduction.

The problem of attaching emotional content to conceptual, lexical or semantic networks is briefly mentioned in the discussion of FIG. 1. There are several approaches to organize and classify concepts and the words that express them, including dictionaries and thesauri, as well as more formal approaches like lexical classifications based on psycho-linguistics, and general purpose semantic networks. One aspect that is lacking in these approaches is emotional valence, i.e. the subjective emotional value that people attach to different concepts. Only recently it has been possible to quantify the extent to which emotional valence affects cognition in the context of increasing neuro-anatomical and neuro-functional knowledge.

Moreover, a theory recently developed by A. Damasio (and partially confirmed by experiments), suggests that specific somatic markers like body temperature of skin conductance can signal, or even precede and trigger conscious cognitive decisions. There are a number of attempts at characterizing the emotional content of specific facial expressions and detecting the emotional state underlying speech utterances. However, lexical databases annotated with emotional valence, such that it can be used as another field for classification and cross-correlation, do not exist at present. The system described earlier in FIGS. 1 and 2 is able to solve this problem.

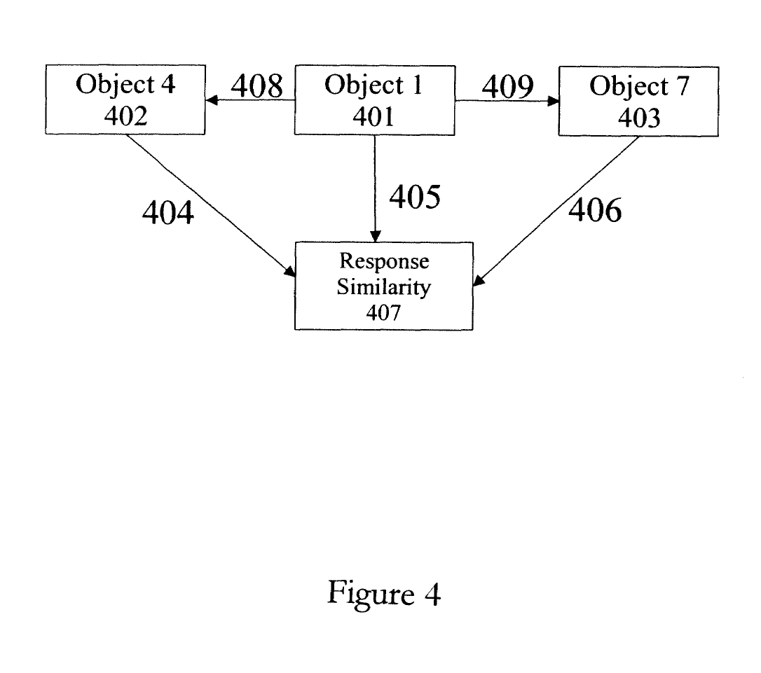

Furthermore, the availability of such a system facilitates the creation of a “meta-thesaurus” as shown in FIG. 4: A given object Oᵢ as described above will be associated with certain weights or distances to a number of physiological response attributes; using a threshold as above, leading to a discrete number of physiological response attributes, Pᵢⱼ. By the same token, these physiological response attributes in turn will be associated with several other objects Oᵢⱼₖ; therefore, an inter-object association will be established between the initial object Oᵢ and the derived objects Oᵢⱼₖ. Suppose there are 10 objects in the database, and the physiological responses for Object 1 are similar to those of Object 4 and Object 7, as indicated by the arrows 404, 405, and 406. Then, the meta-thesaurus will show a relationship between Object 1 and 4, and Object 1 and 7 as depicted in FIG. 4 by arrows 408 and 409. Though there may not be a lexical correspondence between Object 1 and 4, there is a relationship that exists because of the similarity in physiological responses.

Referring to, FIG. 3, this database can then be used without a direct measurement of physiological response attributes as an extended thesaurus such that when a user selects a multimedia object in step 307, the system retrieves an associated set of multimedia objects at step 308. The set of multimedia objects retrieved at step 308 or selected at step 306 can be presented as the output as the user specific desired set of objects 309. The system can also be used to provide context-sensitive information to a user, where the context information is provided by the measured physiological state of the user. For instance, if a user is looking for help on a certain topic on a web site, the system can monitor the user's physiological state to determine the appropriateness of the system response. Thus, if the user appears to get increasingly frustrated, more detailed and explicit help information can be provided. Additional information can be used by the system, for instance, the success of providing detailed help information in the past to subjects with similar physiological state. Thus the system could present a course of action to the user that best addresses the user's physiological state. This would involve creating a database of user's interactions with the system, along with their measured physiological states.

Only a limited set of measurement devices was mentioned in the preferred embodiment. However, the physiological measures can be extended to include more complex measures of brain activity, in addition to the ones already mentioned. Some candidates are functional Magnetic Resonance Imaging (fMRI), Near-infrared Optical Imaging (NIRS), which is a novel non-invasive technique that requires far less setup complexity than fMRI, although at a lower resolution; and Magneto-encephalography (MEG).

While the invention has been described in terms of a preferred embodiment, those skilled in the art will recognize that the invention can be practiced with modification within the spirit and scope of the appended claims.

What we claim as new and desire to secure by Letters Patent is as follows:

1. A method for creating an electronic database of objects that can be converted to sensory stimuli and associated responses, wherein the steps include:
initializing an electronic database to contain a set of objects to be used as stimuli;
connecting at least one of a set of measurement devices to a user;
selecting at least one object of said set of objects from said electronic database to present to said user;
presenting said at least one object of said set of objects to said user;
measuring physiological response attributes of said user to said at least one object of said set of objects;
associating said physiological response attributes of said user with said at least one object of said set of objects that invoked said physiological response attributes; and
updating said electronic database with associations of each of said at least one of said set of objects with said physiological response attributes.

2. The method for aggregating said associations in the database of claim 1, where different physiological response attributes from different users for said at least one object of said set of objects are aggregated together.

3. The method as in claim 2, where the aggregation consists of averaging said physiological response attributes.

4. The method as in claim 2, where the aggregation consists of applying principal component analysis.

5. The method of claim 1 wherein said set of objects are multimedia object files that include but are not limited to audio, video, and photographic images.

6. A method for using objects and associated physiological response attributes stored in a database includes the steps of:
connecting at least one of a set of measurement devices to a user;
measuring physiological response attributes of user;
computing a distance between said measured physiological response attributes and stored physiological response attributes in said database;
presenting said at least one object of said set of objects to said user that correspond to said measured physiological response attributes, wherein said at least one of said set of objects is presented based on a matching threshold of said distance; and
selecting from said set of object at least one object of said set of objects for use by said user.

7. The method of claim 6 wherein said set of objects are multimedia object files that include but are not limited to audio, video, and photographic images.

8. The method as in claim 6, wherein said process of presenting said at least one object of said set of objects that are within said matching threshold involves the use of mutual information or Fisher information.

9. A method for creating a meta-thesaurus where words that evoke a similar physiological response attributes are linked together.

10. A method for creating a database of media objects such that an association is recorded between two objects if they evoke a similar set of physiological response attributes.
